(19) United States
(12) Patent Application Publication
(10) Pub. No.: US 2019/0094520 A1
(43) Pub. Date: Mar. 28, 2019

(54) VISION CORRECTION DEVICE FOR A DISPLAY

(71) Applicants: Carrill D. Kelly, Washington, DC (US); Landon McKenzie, Washington, DC (US); Jeremy T. Thissell, Ashburn, VA (US)

(72) Inventors: Carrill D. Kelly, Washington, DC (US); Landon McKenzie, Washington, DC (US); Jeremy T. Thissell, Ashburn, VA (US)

(21) Appl. No.: 15/933,355

(22) Filed: Mar. 22, 2018

Related U.S. Application Data
(60) Provisional application No. 62/476,150, filed on Mar. 24, 2017.

(51) Int. Cl. G02B 25/00; G02B 3/08; H04N 5/72; H04M 1/02; G02B 27/22; G02C 7/08

(52) U.S. Cl. CPC G02B 25/002; G02B 3/08; G02C 7/086; H04M 1/027; G02B 27/2228; H04N 5/72

(57) ABSTRACT

A vision correction device may include a sheet of transparent material including a converging lens. The converging lens may be configured such that, when the sheet of transparent material is disposed adjacent to a surface, the converging lens refracts light from an image on the surface with an optical power that shortens a viewer's nearpoint distance by an amount that is the same or greater than the reduction in nearpoint distance provided by a 1.0 diopter corrective eyeglasses lens when worn by the viewer.

This application claims priority to Kelly et al., Provisional Patent Application No. 62/476,150, filed Mar. 24, 2017.

### BACKGROUND OF THE INVENTION

### 1. Field of the Invention

The present disclosure relates to vision correction and, more particularly, to vision correction of an image produced by a display screen.

### 2. Description of Related Art

Persons having vision deficiencies can have difficulty viewing display screens of various types. For example, when viewing a handheld device, farsighted users (i.e., those with hyperopia or presbyopia) may not be able to clearly view the image or text on the display if they are not wearing their glasses or contacts. This may be frustrating at particular times, particularly for users who only wear glasses at certain times, such as for reading. A user may not be in a situation where it is convenient to put on their glasses. For example, the user may be trying to read their phone in the middle of the night, when they do not have their glasses handy or their contacts in. Similarly, the user may be outdoors, possibly wearing sunglasses, and may prefer not to put on reading glasses just to view their phone.

Devices and systems have been developed to magnify the image of displays so that any vision deficiency is partially overcome by simply enlarging the image. If letters on a display are large enough, they can be read even if the edges of the letters remain blurry. However, images that have been simply magnified still may not have the desired level of clarity. Further, some users may require a significant optical correction, such that simple magnification of text is not sufficient.

Other systems have been developed that attempt to provide vision corrected images of displays. For example, Huang et al., U.S. Patent Application Publication No. 2016/0042501, published Feb. 11, 2016, and entitled “Vision Correcting Display with Aberration Compensation Using Inverse Blurring and a Light Field Display” discloses a system that uses both hardware and software to enable users to view a display without their glasses. The hardware component is referred to as a “light field element,” and consists of a filter laid over the display. The filter is a sheet of material that has an array of pinholes that correspond with the pixels of the display. The software component operates to pre-blur the image so that, when the light emitted at each pixel passes through a corresponding pinhole on the filter, the result is a vision corrected image. Variations in the software settings can be changed in order to provide different levels and different types of vision correction.

The Huang system, however, requires both hardware and software working together. It is desirable to provide a vision correction device capable of correcting vision deficiencies, beyond simply magnifying the image.

### SUMMARY OF THE INVENTION

There is a need in the art for a system and method that addresses the shortcomings of the prior art discussed above. The disclosed invention is directed to a vision correction device for a display screen.

In one aspect, the present disclosure is directed to a vision correction device. The vision correction device may include a sheet of transparent material including a converging lens. In addition, the converging lens may be configured such that, when the sheet of transparent material is disposed adjacent to a surface, the converging lens refracts light from an image on the surface with an optical power that shortens a viewer's nearpoint distance by an amount that is the same or greater than the reduction in nearpoint distance provided by a 1.0 diopter corrective eyeglasses lens when worn by the viewer.

In another aspect, the present disclosure is directed to vision correction system. The system may include a sheet of transparent material including a converging lens. The converging lens may be configured such that, when the sheet of transparent material is disposed adjacent to a surface, the converging lens refracts light from an image on the surface with an optical power that shortens a viewer's nearpoint distance by an amount that is the same or greater than the reduction in nearpoint distance provided by a 1.0 diopter corrective eyeglasses lens when worn by the viewer. In addition, the vision correction device may be configured to be affixed in proximity to a surface of a display of an electronic device. Also, the system may include a computer-readable medium including instructions for performing one or more functions that facilitate vision correction in conjunction with use of the vision correction device.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 depicts a schematic perspective view of a personal electronic device with a vision correcting film adhered to the display screen.

FIGS. 2-4 depict schematic cross-sectional views of an assortment of converging lenses that may be implemented in the disclosed vision correction device.

FIGS. 5-7 depict schematic cross-sectional views of an assortment of diverging lenses that may be implemented in the disclosed vision correction device.

FIG. 8 is a schematic depiction of the path of light in a farsighted eye.

FIG. 9 is a schematic depiction of a lens correcting the vision of a farsighted eye.

FIG. 10 is a schematic depiction of the path of light in a nearsighted eye.

FIG. 11 is a schematic depiction of a lens correcting the vision of a nearsighted eye.

FIG. 12 is a schematic depiction of how light from a visible object is treated by a farsighted eye.

FIG. 13 is a schematic depiction of how a farsighted person brings the object into focus by holding the object at arm's length.

FIG. 14 is a schematic depiction of how a lens enables a farsighted person to view the object at a closer distance than without the lens.

FIG. 15 is a diagram illustrating how a converging lens magnifies an object.

FIG. 16 is a diagram illustrating how, when the object is adjacent to the lens, a converging lens does not magnify the object, but light from the object is still refracted by the lens.

FIG. 17 depicts a schematic representation of a Fresnel lens shown in cross-section and its correspondence to a similarly performing standard convex lens.

FIG. 18 is a schematic cross-sectional illustration of a one-sided Fresnel lens.

FIG. 19 depicts a schematic perspective view of a display screen and a vision correction device configured to be fitted a frame around the display screen.

FIG. 20 depicts a schematic perspective view a personal electronic device with a replaceable vision correcting display screen.

### DETAILED DESCRIPTION

To assist and clarify the subsequent description of various embodiments, various terms are defined herein. Unless otherwise indicated, the following definitions apply throughout this specification (including the claims).

For purposes of this disclosure, the term “fixedly attached” shall refer to two components joined in a manner such that the components may not be readily separated (for example, without destroying one or both of the components). Exemplary modalities of fixed attachment may include joining with permanent adhesive, rivets, stitches, nails, staples, welding or other thermal bonding, or other joining techniques. In addition, two components may be “fixedly attached” by virtue of being integrally formed, for example, in a molding process.

For purposes of this disclosure, the term “removably attached” shall refer to the joining of two components in a manner such that the two components are secured together, but may be readily detached from one another. Examples of removable attachment mechanisms may include hook and loop fasteners, friction fit connections, interference fit connections, threaded connectors, cam-locking connectors, and other such readily detachable connectors. Similarly, “removably disposed” shall refer to the assembly of two components in a non-permanent fashion.

The disclosed vision correction device may be an accessory for the display screen, a replacement for one or more layers of the display screen, or part of the factory assembled display screen. For example, in some embodiments, the vision correction device may be an accessory, such as a flexible film that may be adhered to a display, a component of a case configured to at least partially enclose the device to which the display belongs, or a rigid or semi-rigid screen configured to be attached to the display and/or to the device to which the display belongs. In some embodiments, the vision correction device may be a replacement component for a display screen. For example, in some embodiments, the vision correction device may be a replacement for the glass of a mobile phone. In some embodiments, the vision correction device may be an original equipment component of the display. For example, a consumer may be able to customize their personal electronic device at the time of purchase by specifying that the display of the personal electronic device be vision correcting. Such customization may permit the user to select the type and degree of vision correction as part of the ordering process.

The following description provides details regarding a vision correction accessory that may be attached to, or otherwise used with, a display screen. However, the capabilities and functionality described below are also applicable to vision correction devices that may be replacement components or original equipment components of display screens.

The vision correction device may be configured for use with any type of display and any size display. For example, in some embodiments, the vision correction device may be configured for use with small displays, such as watch faces, household appliance displays, automobile dashboard displays, etc. In other embodiments, the vision correction device may be configured for use with medium-sized displays, such as handheld electronic devices, e.g., mobile phones, portable gaming devices, electronic reading devices (e.g., KINDLE®, NOOK®, etc.), tablet computers, laptops, and other such personal electronic devices. In other embodiments, the vision correction device may be configured for use with larger displays, such as computer monitors and televisions of any size. Further, in some cases, the vision correction device may be configured for use with non-electronic devices, such as analog watches.

In some embodiments in which the vision correction device is an accessory for a display screen, the vision correction device may be a film that may be applied to the face of the display screen. Such a film may be formed of a flexible, lightweight material. For touchscreen applications, the film may have properties that permit the touch sensitivity and input performance of the display to be at least substantially unaffected. Exemplary materials from which a vision correcting and touch sensitive film may be made include, acrylic, polyurethane, polyvinyl chloride (PVC), and polycarbonate. Skilled artisans will recognize other possible materials suitable for such applications.

In some embodiments, a vision correction device may include a sheet of transparent material including a converging lens. The sheet of transparent material may be placed adjacent to any surface to enable a viewer with a vision aberration to view details of the surface in focus without corrective eyewear (e.g., eyeglasses or contacts). In some embodiments, the sheet of transparent material may be affixed to the surface, for example with an adhesive. In some embodiments, the surface to which the vision correction device may be attached may be a display screen, e.g., of a personal electronic device.

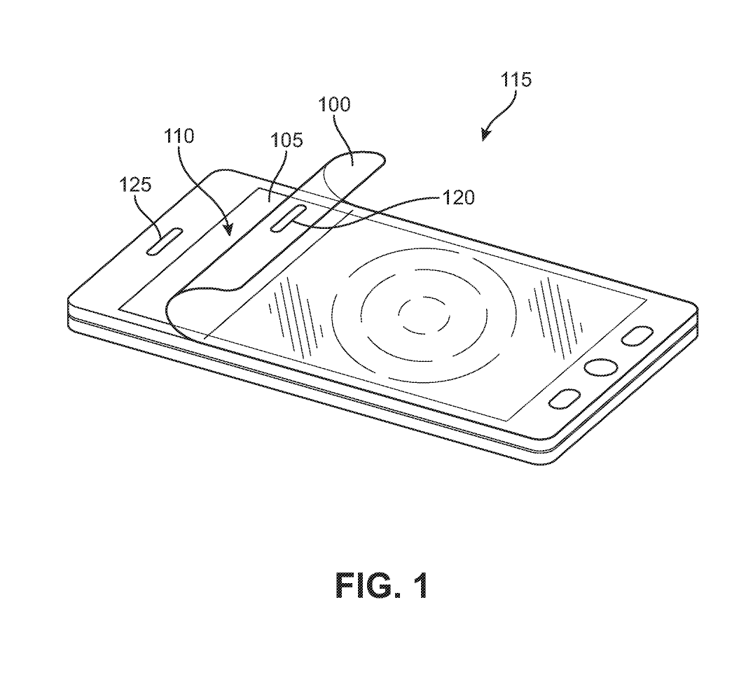

FIG. 1 illustrates an exemplary embodiment of a vision correction device 100. As shown in FIG. 1, vision correction device 100 may include a flexible film, which is illustrated in FIG. 1 as partially peeled away from a surface 105 of a display screen 110 of a personal electronic device 115.

In some embodiments, vision correction device 100 may include openings that are configured to correspond with features of the personal electronic device 115. For example, vision correction device 100 may include one or more openings configured to correspond with speakers, microphones, buttons, or any other features. As shown in FIG. 1, vision correction device 100 includes an opening 120 configured to align with speaker aperture 125 in personal electronic device 115.

In some embodiments, the vision correction device may cover an entire face of the device, as shown in FIG. 1. In other embodiments, the vision correction device may cover less than the entire face of the device. For example, in some cases, the vision correction device may cover only the display area. Further, in some embodiments, the vision correction device may have a non-correcting area and a correcting area. That is, in some cases, a selective portion, such as the center, of the device may have a corrective lens shape, whereas the peripheral portion of the device may simply be transparent with no corrective lens shape. The correcting area may have the same or substantially the same size and shape as a display of the electronic device.

In some cases, the film may include an adhesive on one side for affixing the film to the display. In some embodiments, the adhesive may be a releasable, mild, or otherwise non-permanent adhesive. This may permit the user to readily remove the film when the user is wearing corrective glasses and/or to replace a damaged or worn film or switch to a film with a different prescription. In some embodiments, rather than implementing a mild adhesive, the film may be a cling type material commonly used to adhere temporary advertisements and decorations to windows.

The disclosed vision correction device may be configured to provide any type of vision correction. For example, in some embodiments, the device may be configured to correct for hyperopia (farsightedness) or presbyopia (farsightedness caused by loss of elasticity of the lens of the eye, occurring typically in middle and old age). In some embodiments, the device may be configured to correct myopia (nearsightedness). In some embodiments, the device may be configured to correct for astigmatism or other aberrations.

The disclosed vision correction device may include a converging lens to correct for farsightedness, a diverging lens to correct for nearsightedness, and/or an aspherical lens to correct for astigmatism. Variations may be made to these lenses as compared to lenses provided close to the eye, such as eyeglasses or contact lenses. That is, the vision correction device may be configured to correct vision with the vision correction device located remote from the eye and close to (e.g., adjacent to) the display to be viewed. For example, the optical power of the lens may be increased to provide more refraction than eyeglasses or contact lenses. In such cases, the focal length of the vision correction device may be significantly smaller than for eyeglasses or contact lenses.

To correct hyperopia and myopia, the focal point of the eye is adjusted by adding a lens to the series of lenses in the eye. That is, the lens of eyeglasses or a contact lens includes an optical power that is added to the refraction of the cornea and the lens of the eye.

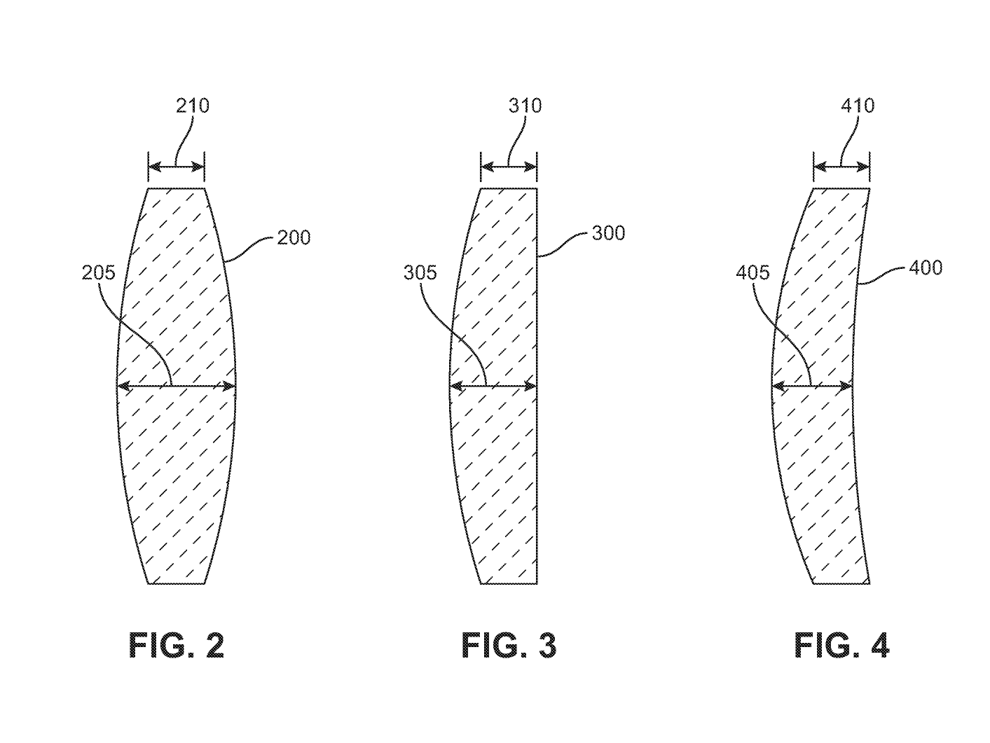

In some embodiments, the vision correction device may include one or more compound lenses. FIGS. 2-7 show a variety of lens types that may be used and, in some cases, combined to provide the desired vision correction.

FIGS. 2-4 depict schematic cross-sectional views of an assortment of converging lenses that may be implemented in the disclosed vision correction device. The converging lenses are thicker in the center than at the periphery. FIG. 2 illustrates a schematic, cross-sectional view of a biconvex lens 200. As shown in FIG. 2, biconvex lens 200 has a central portion having a first thickness 205 and a peripheral portion having a second thickness 210. As also shown in FIG. 2, first thickness 205 is larger than second thickness 210.

FIG. 3 illustrates a schematic cross-sectional view of a plano-convex lens 300. As shown in FIG. 3, plano-convex lens 300 has a central portion having a first thickness 305 and a peripheral portion having a second thickness 310. As shown in FIG. 3, first thickness 305 is larger than second thickness 310.

FIG. 4 illustrates a schematic cross-sectional view of a convex-concave lens 400. As shown in FIG. 4, convex-concave lens 400 has a central portion having a first thickness 405 and a peripheral portion having a second thickness 410. As shown in FIG. 4, first thickness 405 is larger than second thickness 410.

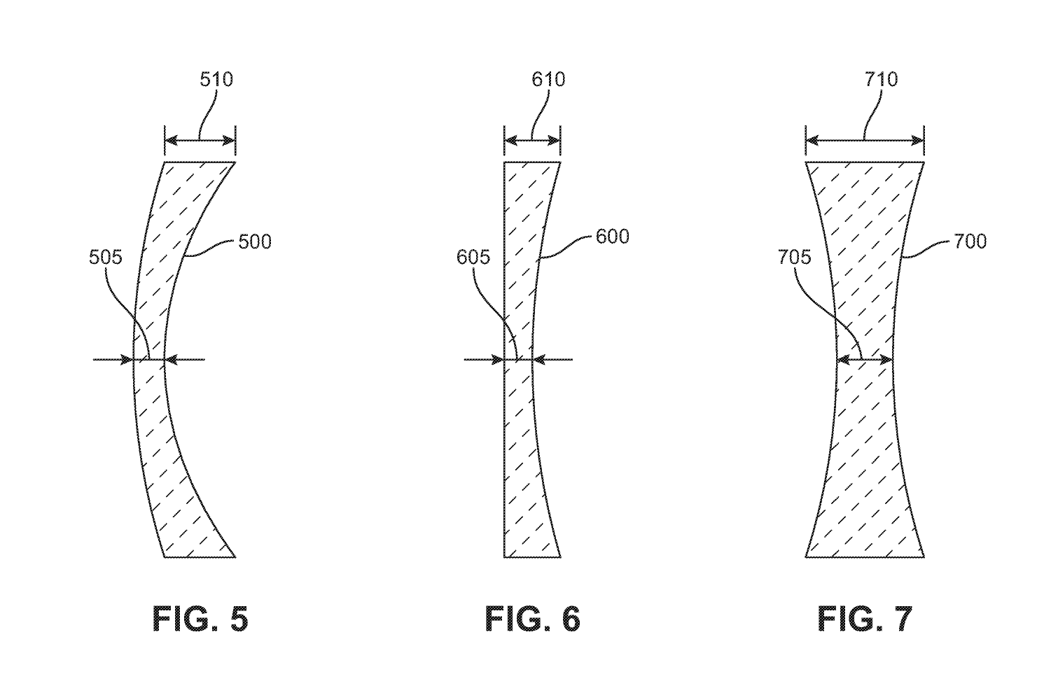

FIGS. 5-7 depict schematic cross-sectional views of an assortment of diverging lenses that may be implemented in the disclosed vision correction device. The diverging lenses are thinner in the center than at the periphery. FIG. 5 illustrates a schematic, cross-sectional view of a meniscus lens 500. As shown in FIG. 5, meniscus lens 500 has a central portion having a first thickness 505 and a peripheral portion having a second thickness 510. As also shown in FIG. 5, first thickness 505 is smaller than second thickness 510.

FIG. 6 illustrates a schematic cross-sectional view of a plano-concave lens 600. As shown in FIG. 6, plano-concave lens 600 has a central portion having a first thickness 605 and a peripheral portion having a second thickness 610. As shown in FIG. 6, first thickness 605 is smaller than second thickness 610.

FIG. 7 illustrates a schematic cross-sectional view of a biconcave lens 700. As shown in FIG. 7, biconcave lens 700 has a central portion having a first thickness 705 and a peripheral portion having a second thickness 710. As shown in FIG. 7, first thickness 705 is larger than second thickness 710.

In some embodiments, the lenses shown in FIGS. 2-7 may be used individually. In other embodiments, two or more of the lenses shown in FIGS. 2-7 may be combined with one another in various combinations. That is, in some embodiments, the vision correction device may include different types of lenses stacked on top of one another.

Further, different types of lens arrangements may be combined. For example, the disclosed vision correction device may include a Fresnel lens and a microlens array layered over or under the Fresnel lens. In some embodiments, the vision correction device may include a Fresnel lens and a lenticular lens. Other combinations of lenses are also envisioned.

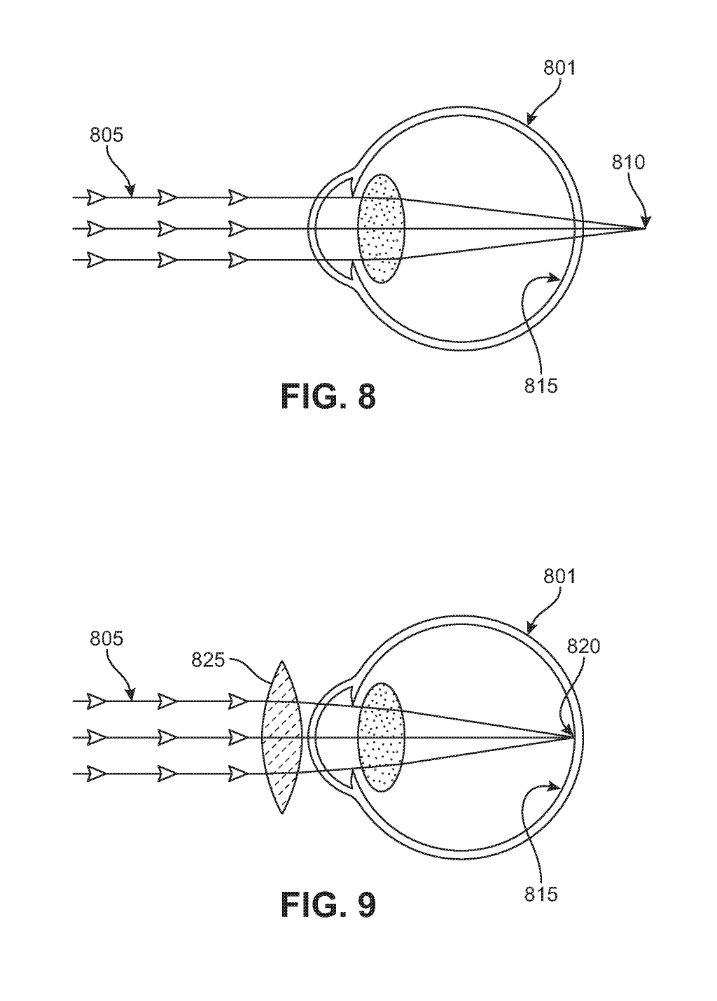

FIGS. 8 and 9 illustrate how a converging lens corrects farsightedness (hyperopia or presbyopia). FIG. 8 is a schematic depiction of the path of light in a farsighted eye. As shown in FIG. 8, a far sighted eye 801 does not have enough accommodation to focus light at the retina 815. That is, farsighted eye 801 lacks the ability to focus light 805 incoming from near objects. Accordingly, light 805 is focused behind retina 815 at a posterior focal point 810.

FIG. 9 is a schematic depiction of a converging lens 825 correcting the vision of farsighted eye 801. As shown in FIG. 9, converging lens 825 refracts the light in a converging manner so that, in conjunction with the refraction provided by the anatomy of the eye (cornea, lens, etc.), light 805 is focused at a focal point 820 on retina 815. Accordingly, to correct hyperopia, corrective eyewear utilizes a converging lens that slightly bends the light in a converging fashion before it hits the cornea. The result is that the focal point is moved further forward such that the focused image is projected onto the retina, as shown in FIG. 11.

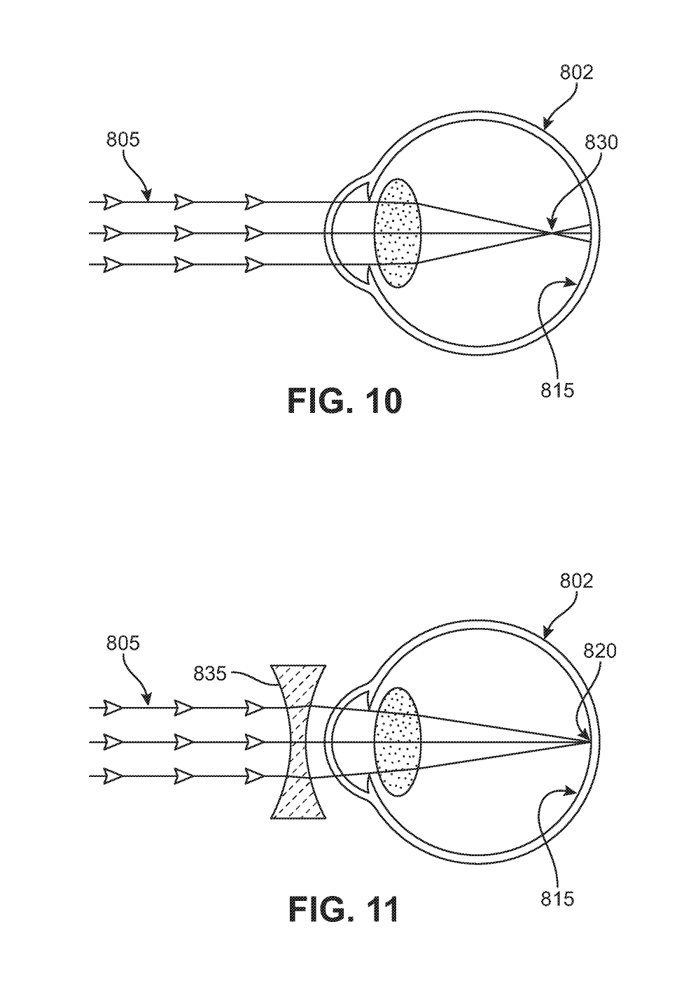

FIGS. 10 and 11 illustrate how a diverging lens corrects nearsightedness (myopia). FIG. 10 is a schematic depiction of the path of light in a nearsighted eye. As shown in FIG. 10, a nearsighted eye 802 focuses the image of incoming light 805 from a distant object in front of retina 815 at an anterior focal point 830. FIG. 11 is a schematic depiction of a lens correcting the vision of a nearsighted eye. As shown in FIG. 11, a diverging lens 835 refracts light 805 in a diverging manner so that it partially offsets the converging refraction provided by the anatomy of the eye. Thus, as shown in FIG. 11, by using diverging lens 835, light 805 may be focused at on-retina focal point 820 instead of in front of it at anterior focal point 830. Accordingly, to correct nearsightedness, corrective eyewear utilizes a diverging lens that slightly bends the light in a diverging fashion before it hits the cornea. The result is that the focal point is moved further rearward such that the focused image is projected onto the retina, as shown in FIG. 11.

To correct for astigmatism, an aspherical lens is used to correct for asymmetrical aberrations in the anatomy of the eye. For example, to correct for astigmatism, the corrective lens may be more convergent or divergent in the vertical direction than in the horizontal direction.

While the vision correction device could be formed to correct nearsightedness and/or astigmatism, the following description discusses correction of farsightedness in more detail. It will be understood that the same or similar concepts also apply to correction of nearsightedness and/or astigmatism.

The term “accommodation” refers to the process by which the eye changes optical power to maintain a clear image or focus on an object as its distance varies. The term “nearpoint” refers to the point nearest the eye at which an object is accurately focused on the retina when the maximum degree of accommodation is employed. For purposes of this disclosure and claims, the term “nearpoint distance” shall refer to the distance between the eye and the nearpoint.

In some embodiments, the disclosed vision correction device may include a converging lens that, when disposed adjacent to a surface, refracts light from an image on the surface with an optical power that shortens a viewer's nearpoint distance by an amount that is the same or greater than the reduction in nearpoint distance provided by a 1.0 diopter corrective eyeglasses lens when worn by the viewer.

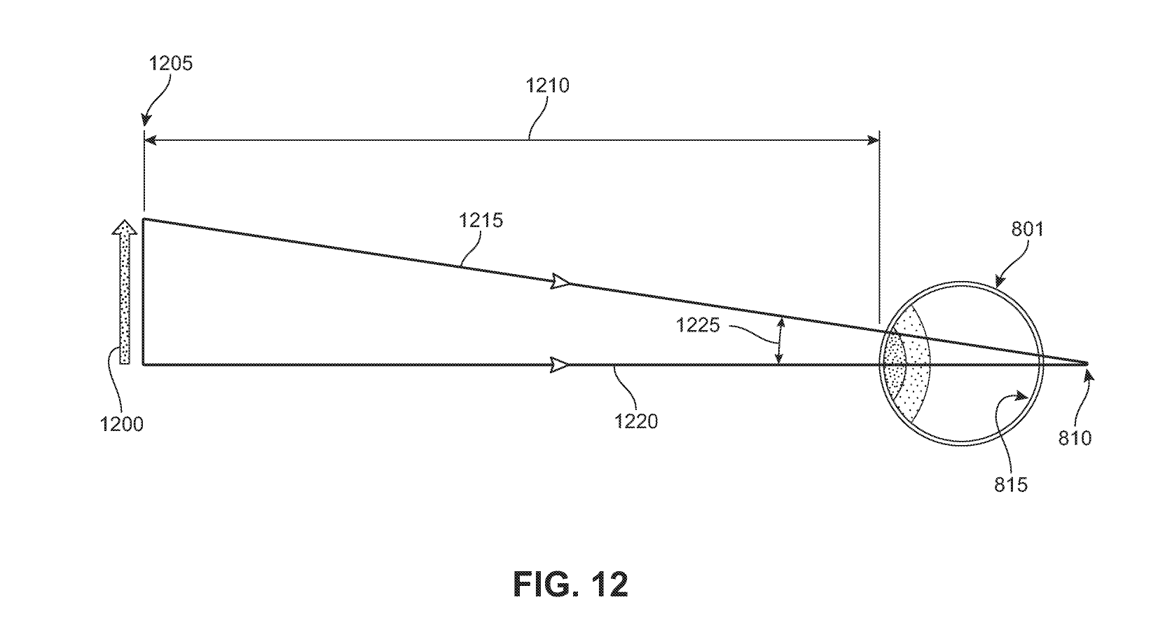

FIGS. 12-14 illustrate how a lens placed adjacent to an object can shorten the distance at which the object can be viewed in focus. FIG. 12 is a schematic depiction of how light from a visible object is treated by a farsighted eye. FIG. 12 shows an object 1200 viewed by a farsighted eye 801 at a nearpoint 1205. Nearpoint 1205 is located at a nearpoint distance 1210. As shown in FIG. 12, light from object 1200 is focused at a posterior focal point 810, which is behind retina 815.

As shown in FIG. 12, the light emitting from the top of object 1200 into farsighted eye 801 is depicted by a top light ray 1215. Similarly, the light emitting from the bottom of object 1200 into farsighted eye 801 is depicted by a bottom light ray 1220. Without vision correction, top light ray 1215 and bottom light ray 1220 converge at posterior focal point 810, creating an angle 1225 between top light ray 1215 and bottom light ray 1220.

Farsighted persons will be familiar with the practice of holding a piece of paper at arm's length rather than at a comfortable reading distance of 12-20 inches from the eyes. With the paper held further away from the eye, the farsighted viewer's reduced capacity for accommodation is sufficient to enable the viewer to view the object in focus. This is inconvenience, however, because some print is too small to be read comfortably at arm's length. Further, some people are so farsighted that they cannot read even larger print at arm's length.

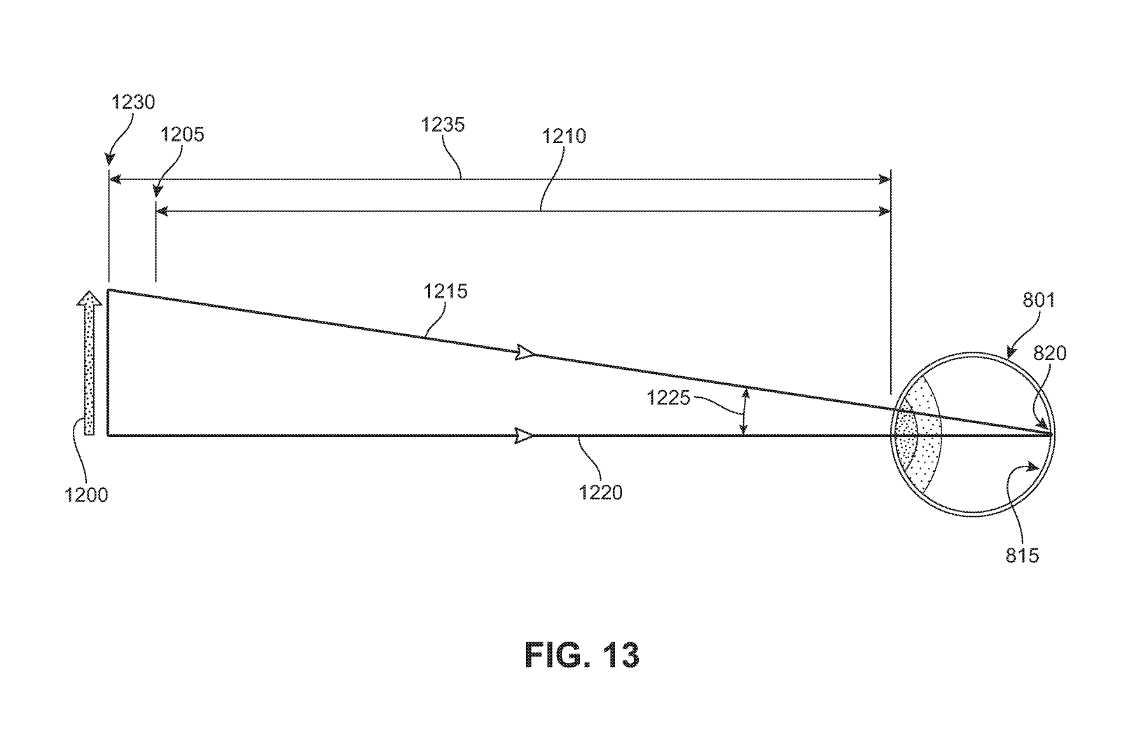

FIG. 13 is a schematic depiction of how a farsighted person brings the object into focus by holding the object at arm's length. As shown in FIG. 13, object 1200 has been moved further to the left to an extended point 1230, which is located at an extended nearpoint distance 1235 from farsighted eye 801. Extended nearpoint distance 1235 is greater than nearpoint distance 1210. As shown in FIG. 13, by moving object 1200 further away from farsighted eye 801, top light ray 1215 and bottom light ray 1220 converge at on-retina focal point 820.

In order for a farsighted viewer to view an object in focus at a closer distance than their extended nearpoint, a converging lens may be placed adjacent to the object. The converging lens refracts the light emitted by the object so that it converges at a steeper angle, enabling the object to be viewed in focus closer to the eye than without the converging lens.

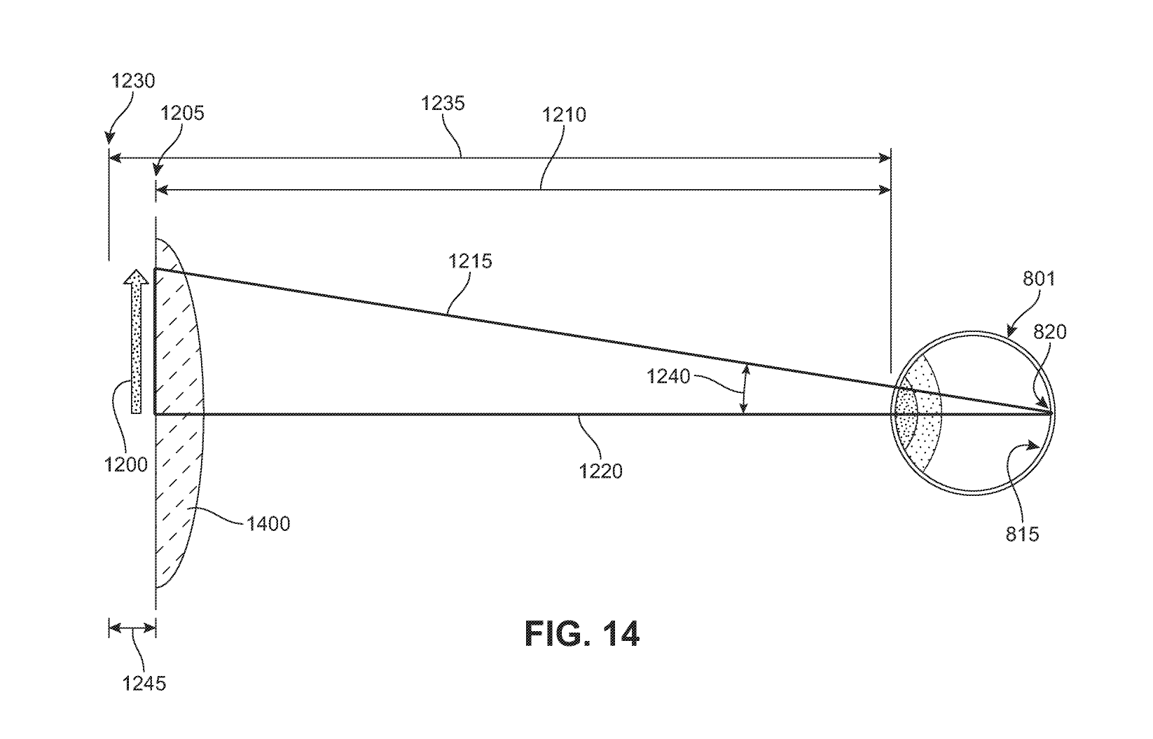

FIG. 14 is a schematic depiction of how a converging lens enables a farsighted person to view the object at a closer distance than without the lens. As shown in FIG. 14, a converging lens 1400 may be placed adjacent object 1200. Doing so causes top light ray 1215 and bottom light ray 1220 converge at a greater angle 1240. This greater angle 1240 enables object 1200 to be viewed at a closer distance than extended nearpoint distance 1235. In some cases, converging lens 1400 may be selected in order to provide the amount of correction that shortens the farsighted viewers nearpoint distance to that of a non-farsighted persion. For example, the object 1200 may be viewed in focus at distance reduced by a dimension 1245.

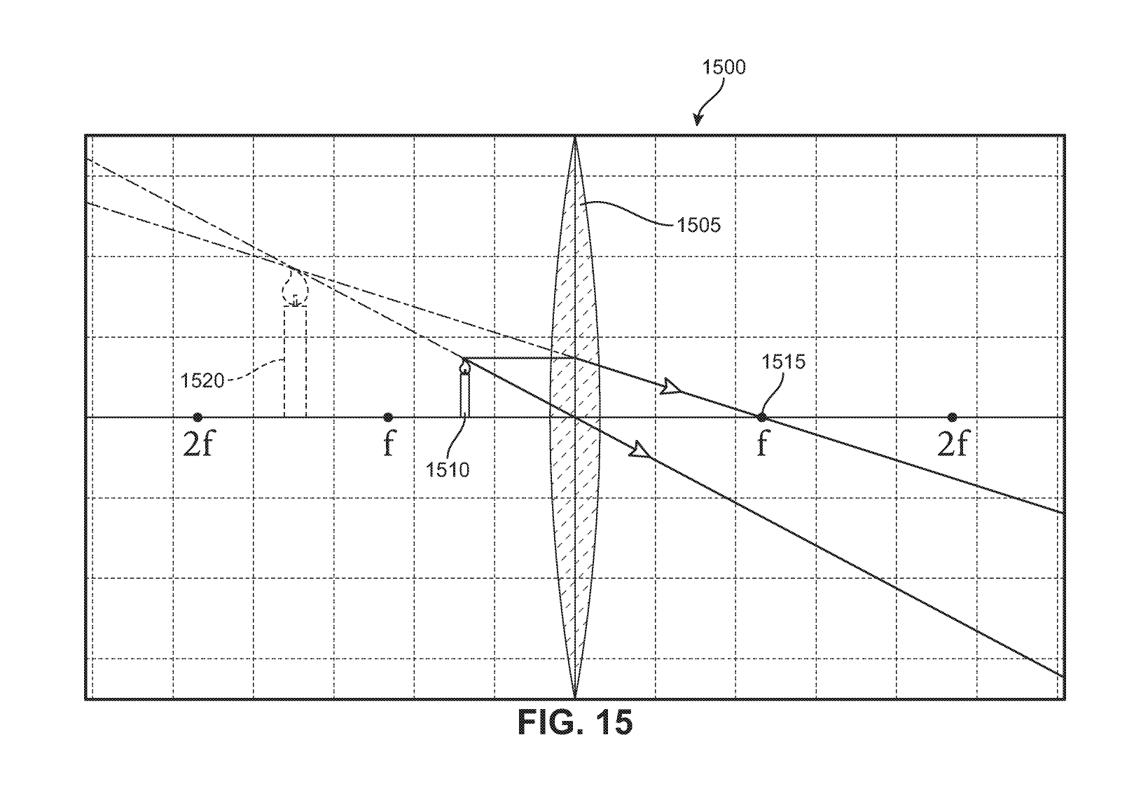

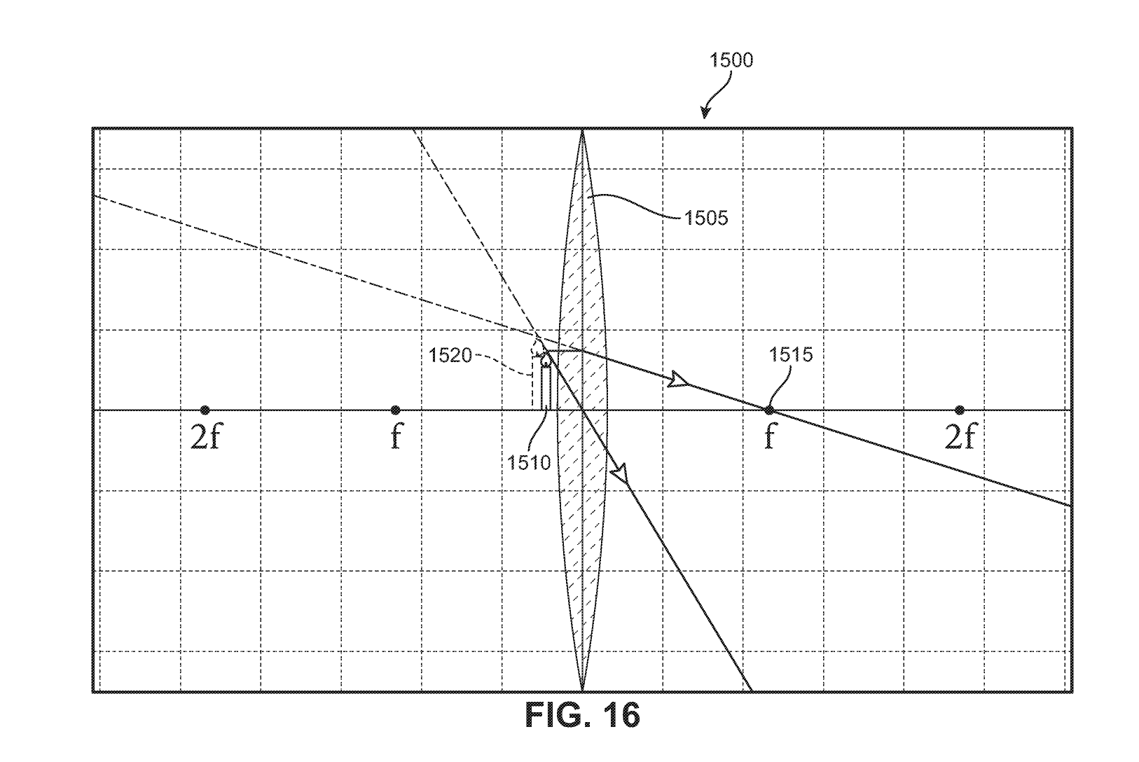

This increase in the angle between top light ray 1215 and bottom light ray 1220 is referred to as “angular magnification.” However, object 1200 is not perceived as any larger than it actually is. This is because converging lens 1400 is disposed adjacent object 1200, which prevents the light rays emitting from object 1200 from dispersing prior to entering converging lens 1400. FIGS. 15 and 16 explain how this vision correction can be provided at the object even though the converging lens does not perceptibly magnify the image of the object viewed by the farsighted viewer.

FIG. 15 is a diagram illustrating how a converging lens magnifies an object when there is space between the object and the lens. As shown in FIG. 15, a lens diagram 1500 represents a converging lens 1505 having a focal point 1515 (“f”). A candle represents the object 1510 to be viewed through converging lens 1505. As shown in FIG. 15, the light rays emitted by object 1510 are refracted by converging lens 1505 in a converging manner through focal point 1515. This creates perceivable magnification, as the viewer sees a virtual object 1520, which is larger than the real object 1510.

FIG. 16 is a diagram illustrating how, when the same object 1510 is positioned adjacent to the same lens 1505, object 1510 is not magnified, but the light emitted from object 1510 is still refracted by lens 1505. As shown in FIG. 16, when object 1510 is moved closer to converging lens 1505, virtual object 1520 gets smaller and closer to real object 1510. When object 1510 is positioned adjacent to lens 1505, the difference in size between virtual object 1520 and real object 1510 is negligible. However, as shown in FIG. 16, the light emitted by real object 1510 is still refracted by lens 1505 through focal point 1515. Due to this refraction without perceived magnification a converging lens placed adjacent a surface can correct for a viewers farsightedness.

The units of optical power when focal length is in meters are called diopters (D). Therefore, a lens having a focal length of 0.25 m would have an optical power of 4.0 diopters (or 4.0 D). Vision correction lenses worn proximate to the eye have optical powers typically in increments of 0.25 D. This is because users generally are unable to tell the difference between increments any smaller than 0.25 D. Converging lenses have a positive optical power (e.g., +3.0 D), whereas diverging lenses have a negative optical power (e.g., −3.0 D).

The fact that optical powers of lenses proximate to one another are approximately additive enables an eye care professional to prescribe corrective lenses as a simple correction to the eye's optical power, rather than doing a detailed analysis of the entire optical system (i.e., the eye and the lens). Optical power can also be used to adjust a basic prescription for reading. Thus an eye care professional, having determined that a myopic (nearsighted) person requires a basic correction of, say, −2 diopters to restore normal distance vision, might then make a further prescription of “add 1” for reading, to make up for lack of accommodation (ability to alter focus). This is the same as saying that −1 diopter lenses are prescribed for reading.

In humans, the total optical power of the relaxed eye is approximately 60 diopters. The cornea accounts for approximately two-thirds of this refractive power (about 40 diopters) and the crystalline lens contributes the remaining one-third (about 20 diopters). In focusing, the ciliary muscle contracts to reduce the tension or stress transferred to the lens by the suspensory ligaments. This results in increased convexity of the lens which in turn increases the optical power of the eye. As humans age, the amplitude of accommodation reduces from approximately 15 to 20 diopters in the very young, to about 10 diopters at age 25, to around 1 diopter at age 50 and over.

Converging lenses have positive dioptric value and are generally used to correct hyperopia (farsightedness) or to allow people with presbyopia (the limited accommodation of advancing age) to read at close range. Diverging lenses have negative dioptric value and generally correct myopia (nearsightedness). Typical glasses for mild myopia will have a power of −1.00 to −3.00 diopters, while over the counter reading glasses will be rated at +1.00 to +3.00 diopters.

The optical power P of a lens is the inverse of the focal length f of a lens.

P=1/f in meters.

Diopters=1/f in meters

magnification=10/f in inches

+3.0 diopter reading lenses have a focal length of 0.33 meter or −13 inches.

+2.0 diopter reading lenses have a focal length of 0.5 meter or −19.7 inches.

+1.0 diopter reading lenses have a focal length of 1 meter or −39 inches.

In some embodiments, the vision correction device may include a converging lens configured such that, when the sheet of transparent material of the vision correction device is disposed adjacent to a surface, the converging lens refracts light from an image on the surface with an optical power that shortens a viewer's nearpoint by a distance that is the same or greater than the reduction in nearpoint provided by a 1.0 diopter corrective eyeglasses lens when worn by the viewer. In order to provide this corrective effect, a lens having a magnification of between 10× and 20× may be used. Since magnification=10/f in inches, lenses having magnification of 10× to 20× have a focal length of 0.5 inch to 1.0 inch. In an exemplary embodiment, a converging lens having magnification of 16× (i.e., focal length 0.625 inches) may be used to provide significant vision correction with the same effect as reading glasses between +1.0 to +3.0 diopters. Although the so-called “magnification” of these lenses is quite significant (10× to 16×), there is virtually no perceived magnification when these lenses are placed adjacent to the surface to be viewed (i.e., the image on the surface to be viewed is substantially unmagnified by the converging lens). However, these lenses are quite powerful, and provide a large amount of refractivity, which corrects for farsightedness even at typical reading distances within arm's length.

That is, the disclosed vision correction device is configured to correct for vision aberrations at a distance from the eye in a predetermined range. For example, rather than a contact lens, which sits on the cornea, or eyeglasses which have lenses that sit a few centimeters from the cornea, the disclosed device is configured to provide vision correction at a distance that a person might hold a handheld personal electronic device, such as a mobile phone or tablet computer. The disclosed vision correction device may be configured to correct vision at a distance from the eye that falls somewhere between approximately 8 inches to 24 inches. Within this range, a focused image may be obtained at a distance that has a significant margin for error, as the focus is not as sensitive to the distance from the eye. In some embodiments, the vision correction may be effected in a range of distances from the eye of several centimeters or several inches. The clarity of the vision correction may reduce as the device is moved toward the ends of the effective range, but there may be several centimeters or several inches within which the vision correction is effective for the user. For example, the user may be able to achieve desired vision correction in a range between 10 inches to 14 inches from the eye. In some embodiments, the effective range may be 11 inches to 13 inches from the eye. Alternatively, in some embodiments, the effective range may be 14 inches to 18 inches from the eye. In some embodiments, the effective range may be 15 inches to 17 inches from the eye. Still smaller ranges are possible.

In some embodiments, the disclosed vision correction device may be adhered directly to the surface of the display. In other embodiments, the device may be spaced from the surface of the display either by open space or by a transparent layer of material. The distance from the surface of the display may facilitate the correction of vision, and may affect the distance from the eye at which the correction is affected.

Although hyperopia-correcting lenses have generally the same configuration as magnifying lenses (i.e., both are converging lenses), the configuration of the disclosed vision correction device to provide vision correction in a desired handheld range distinguishes the lens from a mere magnifying lens. For example, if someone is farsighted (i.e., they have difficulty in seeing near objects, and their spectacle lens prescription has a power beginning “plus”), they will notice that when using a magnifier without their spectacles, the working distance (i.e., the distance between the lens and the object to be viewed) is more than the focal length stated on the magnifier.

As another example, a pair of +4.0 D eyeglasses may correct a farsighted person's vision such that objects are clear when held at 0.25 m (˜9.84 inches) from the lens. The same +4.0 D glasses, if worn by a user who does not need vision correction, would not provide a clear image at 0.25 m, and instead would clearly magnify the object 2× at 0.125 m (˜4.9 inches) from the lens. Therefore, the users must hold the object a different distance from the lens in order to see a focused image. This is because the magnifying lens is not made for use by farsighted people without their corrective eyewear.

Further, the distance at which the +4.0 D glasses provide clear magnification is not particularly practical. That is, it is not typically desirable for a user to have to hold a book 4.9 inches from their face in order to read it, regardless of whether reading it at such a distance provides magnification. Therefore, for all practical purposes, +4.0 D glasses would not be considered to be “magnifying glasses.” Instead, these glasses would be considered “reader glasses,” prescription glasses, or vision correction glasses. In the same way the +4.0 D glasses are considered to be vision correcting and not simply magnifying, the presently disclosed vision correction device provides vision correction in a desirable range of distances at which a user would hold the personal electronic device from their eye to view it. The disclosed vision correction device may provide magnification, but not at a distance at which the user would typically hold the personal electronic device to which the vision correction device is attached.

In other embodiments, due to certain limitations in optics, the vision correction device may provide vision correction at a distance that is greater than would ordinarily be desirable, but still preferred over wearing reading glasses. For example, although a user may prefer to read at 16 inches, the disclosed vision correction device may permit the user to read the display clearly at 20 inches, which is greater than desirable, but less than full arm's length. In such case, the user may prefer the vision correction device to having to dig through their purse to find their reading glasses every time she would like to check her phone. Among the possible limitations that may dictate such a configuration is the proximity of the vision correction device to the surface of the display. Placing a vision correcting film directly onto the surface of a display may limit the viewing range within which vision correction can be provided.

In some embodiments, due to limitations in optics, the vision correction device may provide vision correction at a distance that is less than would ordinarily be desirable, but still preferred to wearing reading glasses. Although a user may prefer to read at 16 inches, the disclosed device may permit the user to read the display clearly at 8 inches. In such case, the user may prefer to use the disclosed vision correction device and hold the personal electronic device at 8 inches rather than put on their reading glasses so it can be read at 16 inches.

Another factor that distinguishes the disclosed vision correction device from magnifying lenses is that the disclosed vision correction device may be affixed directly to the surface of the display. The closer a converging lens is held to an object to be viewed, the less the object will be magnified by the converging lens. When the converging lens is held directly against the object to be viewed, the object will not be magnified significantly. For example, in some cases the object will be magnified by less than 10%, or in some cases less than 5%, and in still other cases less than 1%. While such a configuration, i.e., with a converging lens mounted directly against a display, does not magnify the image appreciably, the lens may provide enough convergence of the image to compensate for a hyperopic viewer's lack of accommodation to enable them to view a focused image of the display within arm's length, whereas they normally would not be able to view the display at such a close distance. Accordingly, such a device may be considered a vision correction device instead of a magnifying device.

Use of the disclosed vision correction device may alleviate the need for a user to utilize corrective eyewear, such as “reader” glasses, prescription glasses, and/or contact lenses. In some embodiments, the vision correction device may be configured to provide correction at pre-determined corrective strengths, similar to “reader” glasses. For example, in some embodiments, the disclosed vision correction device may be produced at pre-manufactured corrective strengths, e.g., 1.0 D, 1.25 D, 1.5 D, 3.0 D, and so on, in a manner similar to available reader glasses.

In some embodiments, the disclosed vision correction device may be provided at custom prescriptions. Further, in some cases, the disclosed vision correction device may provide more complex vision correction, including correction for myopia and/or astigmatism and other aberrations.

The disclosed vision correction device may provide vision correction using one or more of various types of lenses. For example, in some embodiments, the vision correction device may include one or more Fresnel lenses. FIG. 10 depicts a Fresnel lens and how it relates to a corresponding standard convex lens. As illustrated in FIG. 10, the same convergence can be provided with a Fresnel lens that is much thinner than a convex lens of the same optical power. Alternatively or additionally, the vision correction device may include a microlens array. In some embodiments, the vision correction device may include a lenticular lens.

In some embodiments, the vision correction device may be configured to permit unaltered viewing of the display as well as vision correction. For example, in some embodiments, the vision correction device may provide unaltered viewing of the display when viewed from one angle, and vision corrected viewing from a different angle. This capability may be achieved using a lenticular lens and/or a Fresnel lens.

In some embodiments, the disclosed vision correction device, such as the vision correction film may be configured so as to not distort or change the composition of the image shone by the display. For example, by not significantly magnifying the displayed image, the image shone by the display remain the same physical size, and thus, do not compromise the amount of data visible for on-screen viewing, and would not alter the size or location of any displayed items in order to maintain accuracy for touch screen applications.

In addition, embodiments of the disclosed vision correction device that are configured for direct application onto or in abutment with a touch sensitive display may be formed of a material and configuration that maintains the same or substantially similar touch sensitivity as the original display surface. That is, when the sheet of transparent material is placed in contact with a touch screen display, touch screen operation of the touch screen display through the sheet of transparent material is functional. In addition, such materials may also provide protection for the display surface.

In order to maintain touch screen operation through the vision correction device, in some embodiments, the thickness of the sheet of transparent material may be between approximately 0.25 mm and 2 mm. In some embodiments, the thickness of the sheet of transparent material may be approximately 0.015 inches. In order to produce a vision correction device with this thickness, a flexible plastic, such as polycarbonate may be used. In addition, in some embodiments, the vision correction device may include a Fresnel lens.

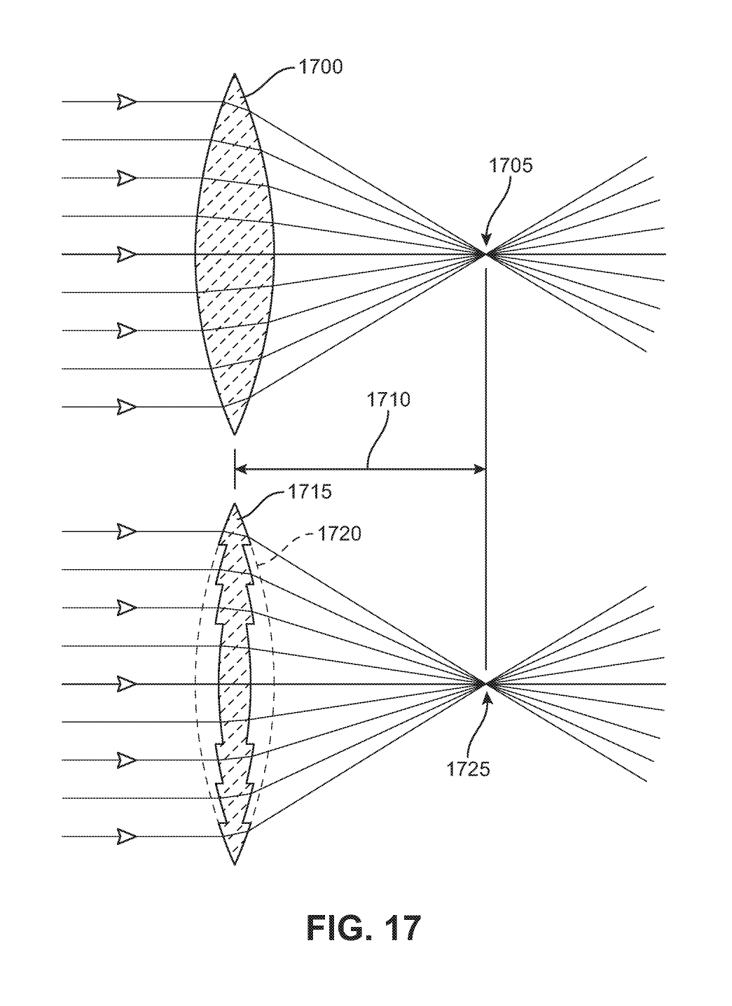

FIG. 17 depicts a schematic representation of a converging Fresnel lens shown in cross-section and its correspondence to a similarly performing standard convex lens. As shown in FIG. 17, a standard convex (converging) lens 1700 refracts light and focuses it at a focal point 1705. Focal point 1705 has a focal length 1710. FIG. 17 also shows a corresponding Fresnel lens 1715. An arced line 1720 illustrates the comparative profile of standard convex lens 1700. Thus, the curvature of Fresnel lens 1715 is the same as standard convex lens 1700, except it is broken into steps, which form ridges in the surface of the lens. As shown in FIG. 17, the total thickness of Fresnel lens 1715 is substantially thinner than standard convex lens 1700. This reduced thickness may facilitate touch screen control through the vision correction device.

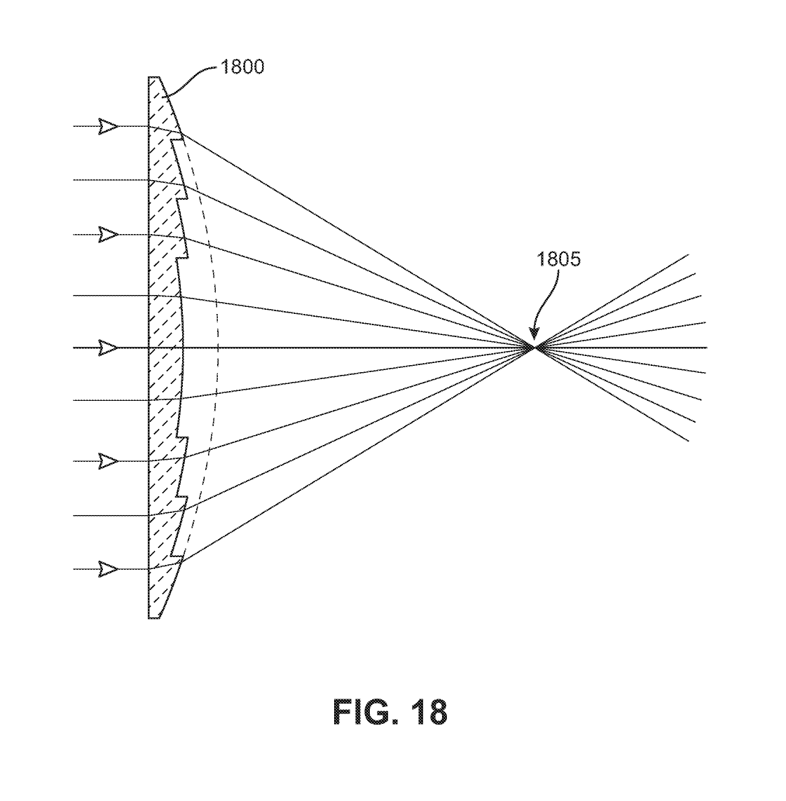

FIG. 18 is a schematic cross-sectional illustration of a one-sided Fresnel lens 1800 having a focal point 1805. In some embodiments, the vision correction device may include a one-sided Fresnel lens 1800. The non-grooved surface of the lens may be placed against or adhered to the surface to be viewed.

The density of grooves is a factor in how thin the lens can be made while maintaining a strong optical power. In some embodiments, the vision correction device may include a Fresnel lens having between 200 and 500 grooves per inch. In some embodiments, the vision correction device may include a Fresnel lens having approximately 200 grooves per inch. In some embodiments, the vision correction device may include a one-sided Fresnel lens having a magnification of 16× (i.e., focal length of 0.625), formed of 0.015 inch thick polycarbonate, with 200 grooves per inch.

The grooves of the Fresnel lens may be formed using any suitable manufacturing method. In some embodiments, the grooves may be formed using a mold. In some embodiments, the grooves may be machined into the surface of the sheet of transparent material. In some embodiments, the grooves may be formed using a laser. In some embodiments, a combination of these manufacturing techniques may be used.

In some cases, the disclosed vision correction device may be a component of a vision correction system. In addition to a vision correction device configured to be affixed in proximity to a surface of a display of an electronic device, the vision correction system may also include software for the personal electronic device to which the vision correction device may be attached. In some cases, the software may be configured to alter the image produced by the display. In some cases, the software may be configured to facilitate vision correction independent of any pre-alteration of the image by the personal electronic device.

In some embodiments, the system may include a computer-readable medium including instructions for performing one or more functions that facilitate vision correction in conjunction with use of the vision correction device. In some embodiments, the software may work in concert with the vision correction device to provide the vision correction by altering the image produced by the display. In some embodiments, the instructions may be configured to be incorporated into a computer readable memory of a personal electronic device.

Exemplary functions that facilitate vision correction may include activating an alert produced by the personal electronic device, the alert indicating whether the object and vision correction device are held at a viewing distance in which a focused image is produced with viewing correction. As explained in further detail below, in some embodiments, the alert may be selected from the group consisting of a tactile alert, an audible alert, and a visual alert.

The altered image may then be further adjusted by the vision correction device. For example, in some embodiments, the software may pre-process the image displayed by the screen. For instance, in some embodiments, the vision correction device may provide vision correction wherein the focused, vision-corrected image is produced inverted. In such embodiments, software may be available that pre-inverts the image (both vertically and horizontally) displayed by the electronic device. When the vision correction device inverts the image a second time, the result is an image that is right side up as seen by the viewer. For certain prescriptions, producing a pre-inverted image using software and inverting the image again with the vision correction device may enable a focused image to be produced at a viewing distance (from the eye to the screen) that is desirable.

In some embodiments, the software may be part of the original programming of the personal electronic device. In other embodiments, the software may be downloadable. In some cases, the software (downloaded or otherwise) may be incorporated into the settings portion of the device programming. In other embodiments, the software may be available as a separate application (i.e., an “app”). The user may use the software to select whether the displayed image is inverted so that the personal electronic device can be used without a vision correction device, with a vision correction device that inverts the image, or with a vision correction device that does not invert the image.

In some embodiments, the software, independent of any alterations made to the image displayed by the screen, may assist the user to hold the personal electronic device at a distance from the eye in which the vision correction is most effective. For example, in some embodiments, the software may be configured to utilize the personal electronic device to detect the distance from the user's eye and provide an alert when the device is held within the working range and/or provide an alert when the device is held outside the working range. The alert may be audible or tactile. For example, a user's phone may provide a beep or tone when the device is held outside of the working range, and may provide a vibration when the phone is brought into the working range. Other suitable types and combinations of alerts may be utilized.

In order to implement these working distance alerts, eye reading technology may be utilized. That is, technology that reads where the user is looking on the screen may also detect how far away the eye is from the screen. The user may set up the personal electronic device according to the prescription of the vision correction, the parameters of the vision correction film, and calibrate the eye tracking system to the user's eye. If the user's prescription changes, the settings in the device can be readily changed accordingly.

While the distance alerting software may be independent of any pre-alteration software, in some embodiments, a personal electronic device may use both for pre-alteration of the displayed image and modules for alerting the user regarding the distance the device is held from the eye.

The embodiments discussed above are generally directed to a film that may be applied (in some cases adhesively) to a display, as shown in FIG. 1. Such a film may be flexible. In some cases, a similar device may be rigid or semi-rigid. For example, in some embodiments the vision correcting screen device might be a glass or hard plastic overlay. In some embodiments, the rigid or semi-rigid overlay may be adhered with a mild adhesive, as discussed above with respect to the film embodiment.

In some embodiments, the vision correction device may be a component of an attachment or case configured to at least partially enclose the personal electronic device. For example, a personal electronic device case may include a vision correcting screen cover incorporated into the case. In some embodiments, such a screen cover may be adhered to the display surface using a mild adhesive or cling type attachment, as discussed above. In other embodiments, such a screen cover may have similar properties as discussed above with respect to vision correction, but may operate simply by being positioned adjacent or close to the surface without being adhered to it. In other embodiments, a vision correction device may be attached to the personal electronic device with a strap or other attachment mechanism.

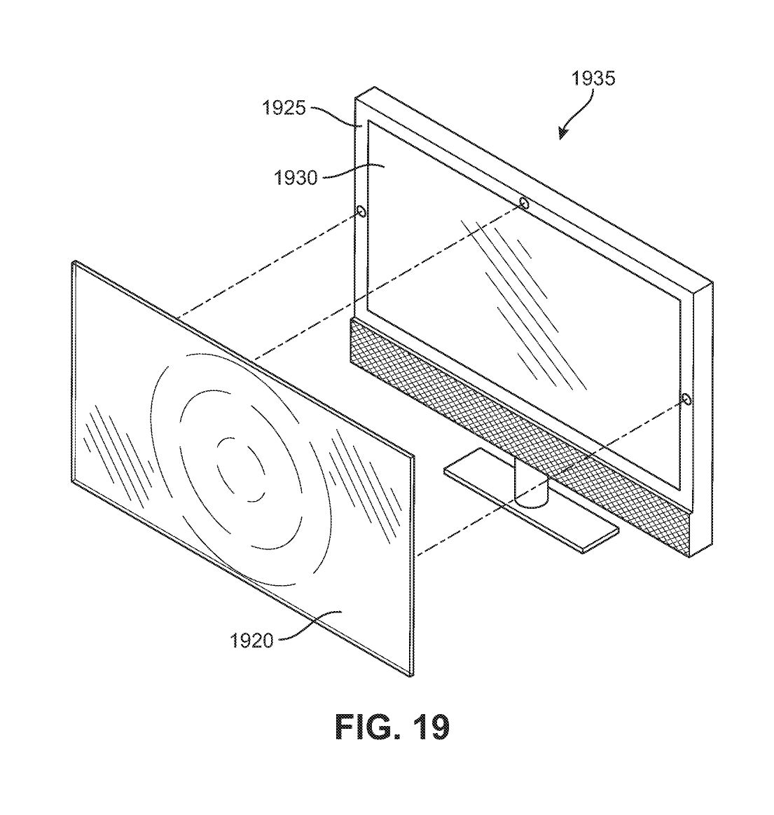

In some embodiments, the vision correction device may be affixed to a screen at or around the periphery of the screen, as shown. For example, as shown in FIG. 19, in some embodiments, a vision correction device 1920 may be attached to a frame 1925 in which a display screen 1930 of a display device 1935 is housed. As shown in FIG. 19, display device 1935 may be a television or computer screen.

In some embodiments, the vision correction device may be adhered to the display surface itself, but only at the edges and/or corners of the display. Also, mobile phones, tablets, and other personal electronic devices often have portions of the display surface that are not part of the screen. For example, such devices often have substantially their entire front surfaces formed of a single piece of glass, but a thin border around the perimeter does not illuminate as part of the display. In some embodiments, the disclosed vision correction device may be attached to these non-illuminating areas around the screen.

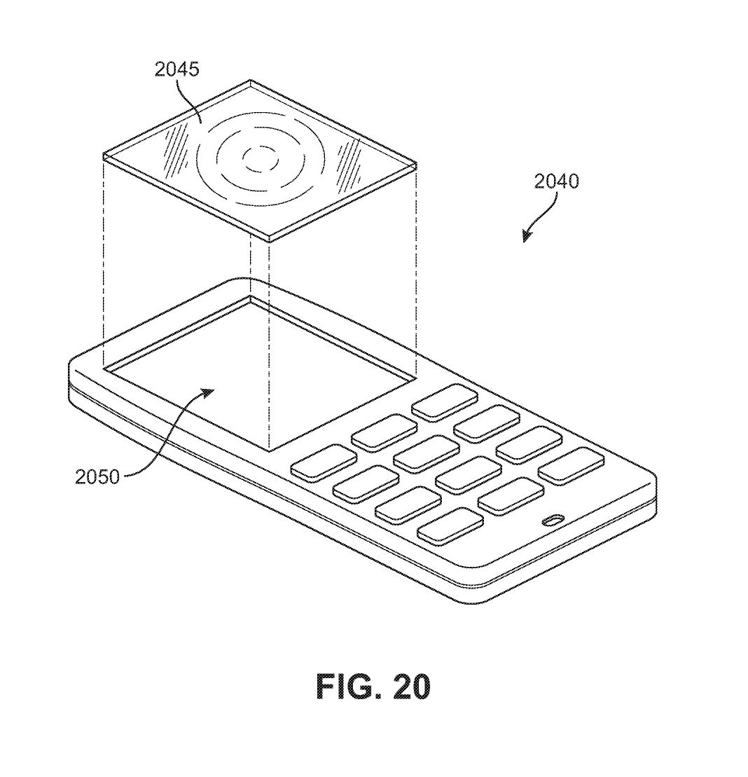

In some embodiments, the display screen itself may be formed with a vision correction capability built into it. Such a vision correcting display screen may be made as a replacement to an original equipment screen. As shown in FIG. 20, a personal electronic device 2040 may include a replaceable vision correcting display screen 2045, which may be received within a recess 2050 in device 2040.

Alternatively, such a vision correcting display screen may be incorporated into the original assembly of the device. For example, a user, when ordering a new personal electronic device, may specify various options including color, memory, and other specifications. As part of these selections, the user may choose a vision correcting screen, and may specify the prescription.

Any of the alternative embodiments disclosed above may have the same or similar vision correction configurations as discussed above with respect to the vision correction film embodiment. In addition, with any of the embodiments disclosed above, other features of the vision correction device may be available. For example, the vision correction device may include anti-glare, tint, scratch resistance, high refraction material, extra lightweight material, or other features.

In addition, any of the embodiments disclosed above may be provided with a configuration that provides magnification. In some embodiments, the magnification may be provided in addition to the vision correction. In other embodiments, the magnification may be provided without vision correction. The device may be configured to provide magnification at a suitable viewing distance, as discussed above with respect to the ranges of distances within which a clear vision corrected image is produced.

A person of ordinary skill in the art will readily recognize how to implement various lens configurations and other aspects of the concepts described above, as well as materials that may be suitable for such implementations.

While various embodiments of the invention have been described, the description is intended to be exemplary, rather than limiting and it will be apparent to those of ordinary skill in the art that many more embodiments and implementations are possible that are within the scope of the invention. Any feature of any embodiment may be used in combination with or as a substitute for any other feature or element in any other embodiment unless specifically restricted. Accordingly, the invention is not to be restricted except in light of the attached claims and their equivalents. Also, various modifications and changes may be made within the scope of the attached claims.

We claim:

1. A vision correction device, comprising:
a sheet of transparent material including a converging lens;
wherein the converging lens is configured such that, when the sheet of transparent material is disposed adjacent to a surface, the converging lens refracts light from an image on the surface with an optical power that shortens a viewer's nearpoint distance by an amount that is the same or greater than the reduction in nearpoint distance provided by a 1.0 diopter corrective eyeglasses lens when worn by the viewer.

2. The vision correction device of claim 1, wherein the focal length of the converging lens is between approximately 0.5 inch and 1.0 inch.

3. The vision correction device of claim 1, wherein when the sheet of transparent material is disposed adjacent to the surface, the image on the surface is substantially unmagnified by the converging lens.

4. The vision correction device of claim 1, wherein, when the sheet of transparent material is placed in contact with a touch screen display, touch screen operation of the touch screen display through the sheet of transparent material is functional.

5. The vision correction device of claim 1, wherein the thickness of the sheet of transparent material is between approximately 0.25 mm and 2 mm.

6. The vision correction device of claim 5, wherein the thickness of the sheet of transparent material is approximately 0.015 inches.

7. The vision correction device of claim 6, wherein the sheet of transparent material is formed of polycarbonate.

8. The vision correction device of claim 1, wherein the converging lens is a Fresnel lens.

9. The vision correction device of claim 8, wherein the Fresnel lens has between 200 and 500 grooves per inch.

10. The vision correction device of claim 1, wherein the sheet of transparent material is a flexible film configured to be adhered to a surface of a display screen.

11. The vision correction device of claim 10, wherein the flexible film is configured to be adhered by one of an adhesive and a cling material.

12. A vision correction system, comprising:
a sheet of transparent material including a converging lens;
wherein the converging lens is configured such that, when the sheet of transparent material is disposed adjacent to a surface, the converging lens refracts light from an image on the surface with an optical power that shortens a viewer's nearpoint distance by an amount that is the same or greater than the reduction in nearpoint distance provided by a 1.0 diopter corrective eyeglasses lens when worn by the viewer;
wherein the vision correction device is configured to be affixed in proximity to a surface of a display of an electronic device; and
a computer-readable medium including instructions for performing one or more functions that facilitate vision correction in conjunction with use of the vision correction device.

13. The vision correction system of claim 12, wherein the instructions are configured to be incorporated into a computer readable memory of a personal electronic device.

14. The vision correction system of claim 13, wherein the one or more functions include activating an alert produced by the personal electronic device, the alert indicating whether the object and vision correction device are held at a viewing distance in which a focused image is produced with viewing correction.

15. The vision correction system of claim 14, wherein the alert is selected from the group consisting of a tactile alert, an audible alert, and a visual alert.

16. The vision correction system of claim 12, wherein the vision correction device is a flexible film configured to be adhered to the surface of the display.

17. The vision correction system of claim 12, wherein the converging lens is asymmetrical and is configured to correct astigmatism.

18. The vision correction system of claim 12, wherein the converging lens is a Fresnel lens.

19. The vision correction system of claim 12, wherein when the sheet of transparent material is disposed adjacent to the surface, the image on the surface is substantially unmagnified by the converging lens.

20. The vision correction system of claim 12, wherein, when the sheet of transparent material is placed in contact with a touch screen display, touch screen operation of the touch screen display through the sheet of transparent material is functional.
